(19) United States
(12) Patent Application Publication
(10) Pub. No.: US 2026/0202173 A1
(43) Pub. Date: Jul. 16, 2026

(54) VISUAL-ELECTRONIC WIND INDICATOR TECHNOLOGY SYSTEMS AND METHODS

(71) Applicant: Raymond E. Cline, Jr., Montgomery, TX (US)

(72) Inventor: Raymond E. Cline, Jr., Montgomery, TX (US)

(21) Appl. No.: 19/020,131

(22) Filed: Jan. 14, 2025

(51) Int. Cl. F41G 3/08; F41J 5/06; G01P 13/04

(52) U.S. Cl. CPC F41G 3/08; F41J 5/06; G01P 13/045

(57) ABSTRACT

The present disclosure relates generally to visual-electronic wind indicator technology (“ViEWIT”) wind flag systems and methods for target shooting comprising one or more ViEWIT wind flags and a base unit that receives sensor data from a ViEWIT wind flag and displays data based on the received data. Additionally, the present disclosure relates to a system wherein multiple ViEWIT wind flags can communicate with each other to form a mesh network, or alternatively, act as repeaters for ViEWIT wind flags located farther away from a shooter.

### BACKGROUND

Target shooting sports at medium (25 meters to 100 meters) and long (100 meters to 1000+ meters) distances benefit from timely and accurate downrange wind conditions (e.g., wind direction and velocity) and environmental conditions (e.g., temperature, pressure, and/or humidity). Historically, wind conditions have been determined either by reading analog wind flags or more recently by receiving electronic data indicative of wind conditions.

### SUMMARY

The present disclosure includes visual-electronic wind indicator technology (“ViEWIT”) wind flag devices, systems, and methods which combine electronic measurement and electronic display of wind conditions with one or more visually observable physical indications of one or more wind conditions, each approximately along a bullet's path, to facilitate windage, elevation, and other bullet trajectory compensation for target shooting sports.

According to one aspect of one or more embodiments of the present invention, a system includes one or more wind flags and a base station. Each wind flag in the system includes a visually-observable physical indication of horizontal wind direction, an electronic horizontal orientation sensor, a visually-observable physical indication of wind speed, an electronic wind speed sensor, and a wind flag communication system. The base station includes a display and a base station communication system. The base station is configured to receive horizontal wind direction data and wind speed data at each wind flag, present on the display an indication of respective horizontal wind direction and respective wind speed at each wind flag, present on the display an indication of a respective location of each wind flag, and present on the display an indication of horizontal bullet deflection determined at least in part from received horizontal wind direction data and wind speed data.

Other aspects of the present invention will be apparent from the following description and claims.

### BRIEF DESCRIPTION OF THE DRAWINGS

Illustrative examples of the present disclosure are described in detail below with reference to the attached drawing figures, which are incorporated by reference herein, and wherein:

FIG. 1 depicts a side view of a ViEWIT wind flag, according to an example embodiment.

FIG. 2 depicts a top view of a ViEWIT wind flag, according to an example embodiment.

FIG. 3 is a simplified block diagram illustrating components of a ViEWIT wind flag, according to an example embodiment.

FIG. 4 depicts a front view of base station, according to an example embodiment.

FIG. 5 is a simplified block diagram illustrating components of a base station, according to an example embodiment.

FIG. 6 illustrates a simplified top view, not to scale, of a target range with a ViEWIT wind flag system, according to an example embodiment.

FIG. 7 illustrates a data screen displayed on a base station, according to an example embodiment.

FIG. 8 illustrates a deflection-over-time screen displayed on a base station, according to an example embodiment.

FIG. 9 illustrates a range condition screen displayed on a base station, according to an example embodiment.

FIG. 10 illustrates a prevalent condition screen displayed on a base station, according to an example embodiment.

FIG. 11 illustrates a simplified top view, not to scale, of a target range with a ViEWIT wind flag system operating in a direct communication mode, according to an example embodiment.

FIG. 12 illustrates a simplified top view, not to scale, of a target range with a ViEWIT wind flag system operating in a repeater communication mode, according to an example embodiment.

FIG. 13 illustrates a simplified top view, not to scale, of a target range with a ViEWIT wind flag system operating in a mesh communication mode, according to an example embodiment.

### DETAILED DESCRIPTION

### I. Overview

The present disclosure relates generally to ViEWIT wind flag systems for target shooting wherein the system may comprise one or more ViEWIT wind flags and a base station. Multiple ViEWIT wind flags collect wind condition data and environmental data at multiple locations downrange and communicate their collected and/or processed data to the base station for monitoring and displaying various current, prevalent, and/or trend conditions across the target range. Further, the present disclosure relates to a system wherein multiple ViEWIT wind flags can communicate with each other to form a mesh network, and additionally or alternatively, act as repeaters for ViEWIT wind flags located farther away from a base station located near the shooter.

The ViEWIT wind flag system serves as an aid to sport and competition shooters for gathering, analyzing, transforming, and presenting wind conditions, environmental conditions, and other data that is valuable for setting pre-shot elevation and windage sighting adjustments, quickly adjusting windage and/or elevation holdover target sight location in a reticle at the time of a shot, and providing historical and post-shot data for subsequent analysis after a shot or series of shots.

Analog wind flags have long been in common use for providing a visual physical indication of wind conditions for target shooters, allowing an experienced shooter to make an approximation of wind direction and wind velocity downrange. More recently, electronic wind flags have entered the market. Electronic wind flags collect data at one or more points downrange and present the shooter with more accurate wind velocity and direction, and can present the data, or calculations based on the data, to a shooter at a shooting station.

Both analog and electronic wind flags have advantages and disadvantages. Analog windflags require significant experience to read properly, and even then provide only a rough approximation of the wind conditions. This hampers accurate pre-shot windage and elevation adjustments on the rifle scope, as well as accurate final holdover aim point adjustments through the reticle. However, analog wind flags allow for very fast focus time and information acquisition, allowing a shooter to remain in shooting position and switch between a through-the-scope sightline and a downrange field-of-view encompassing one or more analog flags with minimal eye or head movement just prior to shooting. This permits the shooter to make a windage holdover adjustment based on instantaneous wind conditions immediately prior to firing. Conversely, electronic wind flags can provide highly accurate wind conditions and potentially certain other environmental conditions, which can then be used to dial in precise windage and elevations adjustments on the scope during initial setup of the shot. However, viewing the electronic data in real time immediately prior to taking the shot requires a shooter to change focus from a through-the scope long distance focal point (the target) to an extremely near-field focus point (the electronic wind flag data display terminal) and back. This can result in undesirable head, rest, hold, and body movement and can delay or impair target re-acquisition.

Therefore, it is desirable to synergistically integrate the sighting advantages of analog wind flags with the precision and data presentation of electronic wind flags in the form of the ViEWIT wind flag system described herein, allowing a competition target shooter to dial in precise pre-shot windage and elevation adjustments while maintaining downrange focus and benefiting from final holdover aim point adjustments immediately prior to firing.

Additionally, by providing precise electronic data simultaneously with viewable physical indications of wind conditions, the ViEWIT wind flag system disclosed herein beneficially trains less-experienced shooters to read analog wind flags. Also additionally, the ViEWIT wind flag systems disclosed herein provide enhancements over current electronic and analog wind flags in the form of additional data collection, analyses, transformation, and presentation.

The ViEWIT wind flag systems herein further improve on existing electronic systems through the use of detailed distributed data that can be analyzed and presented in new ways to enhance interpretation of the downrange environment. Additionally, the ability to visually correlate the detailed data and analysis with traditional visual observations enhances a shooter's interpretation of the wind conditions and environmental conditions and provides a mechanism to recognize and quickly adjust for anomalies and transient conditions.

Additionally, collecting data from a distributed set of ViEWIT wind flags with known geographic positions relative to each other, the shooter, and the target allows for both simple presentation and, alternatively or additionally, more complex analysis and presentation.

At the most rudimentary level, the base station herein can dynamically present wind conditions (e.g., wind direction and wind velocity), environmental conditions, and/or geographic positions of each ViEWIT wind flag.

Additionally or alternatively, ViEWIT wind flag systems herein can use wind direction data and wind velocity data, relative to the theoretical target line, to determine an apparent wind acting on the bullet and further aggregate that into an estimate of overall wind impact, each of which can be displayed on a base station, for example as a bullet deflection value due to wind conditions.

As another example, additionally or alternatively, ViEWIT wind flag systems herein can calculate time averages and display, via the base station, trends in wind conditions and, in some embodiments, environmental conditions.

As another example, additionally or alternatively, ViEWIT wind flag systems herein can determine periods of stable wind conditions and display information indicative of the most prevalent wind conditions, and in some embodiments, a graphical display of corresponding flag shapes for those prevalent wind conditions.

As another example, additionally or alternatively, ViEWIT wind flag systems herein can determine air density and fluctuations in air density, which can be incorporated into ballistic calculations for drop and bullet deflection due to wind.

As another example, additionally or alternatively, ViEWIT wind flag systems herein can analyze other environmental data (e.g., temperature, humidity, and pressure) to determine relatively static measurements which have been shown to impact shooting precision.

As another example, additionally or alternatively, ViEWIT wind flag systems herein can act as a shot detector and log time-stamped shot, wind condition, and/or other environmental conditional data, across the length of the range, each time the system detects a shot.

### II. Example ViEWIT Wind Flag

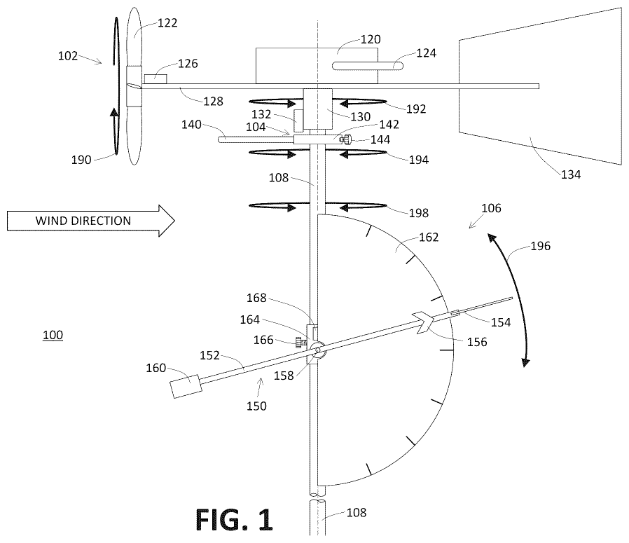

FIG. 1 depicts a side view of a ViEWIT wind flag, according to an example embodiment.

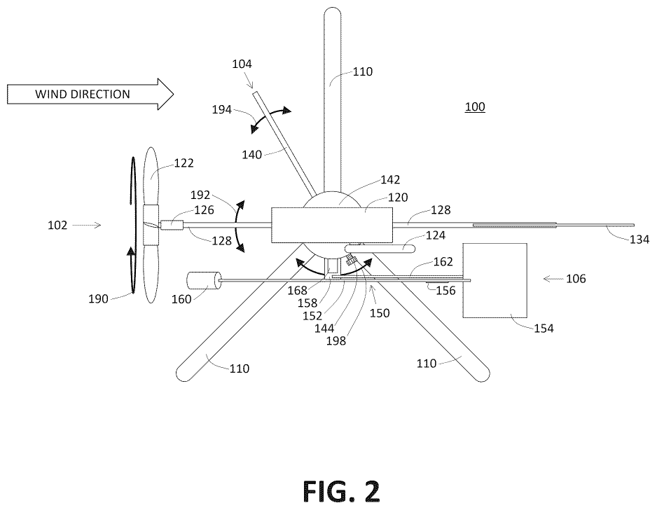

The ViEWIT windflag 100 includes a vertical cylindrical stand 108 intended to be placed alongside and/or in proximity to a theoretical target line between a shooter and a target. The stand 108 may have legs 110 (see FIG. 2) that allow a stable placement on the ground or other surface, or may otherwise be temporarily, semi-permanently, or permanently fixed alongside and/or in proximity to the theoretical target line.

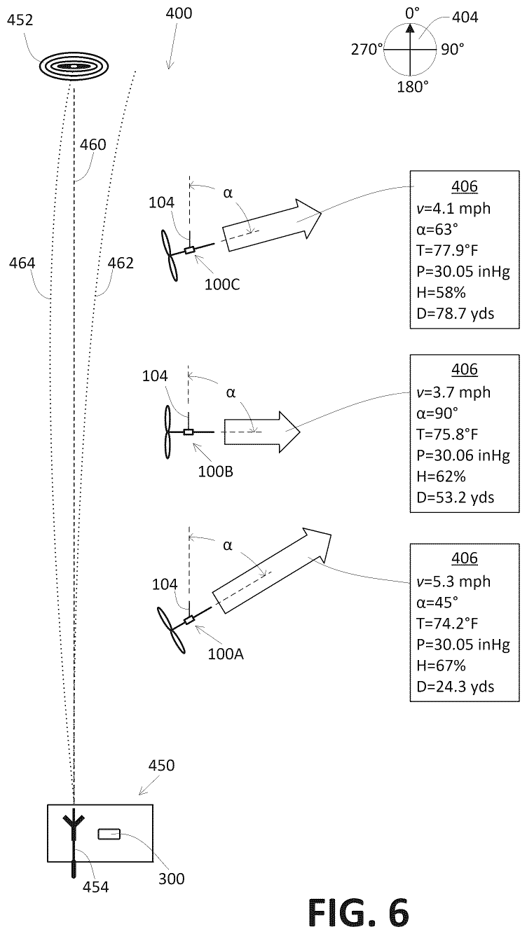

An orientation indicator 104 may be mounted to the stand. The orientation indicator 104 may be adjustable and may optionally be used to provide a reference orientation for the specific ViEWIT wind flag 104 in an overall ViEWIT wind flag system, which may include one or more ViEWIT wind flags 100 and a base station 300 (see, e.g., FIG. 6). The orientation indicator 104 may include an orientation pointer 140, a rotational mount 142, and a set screw 144 or other fixation means. The rotation mount 142 allows the orientation indicator 104 to be rotated about the stand 108, as indicated by rotation direction 194 and preferably in a horizontal plane, to a desired orientation. The set screw 144 or other fixation means can then be used to fix the orientation indicator 104 in place and prevent further rotation. The orientation pointer 140 is preferably aimed along a known direction, such as parallel to the theoretical target line between the shooter and the target, or alternatively to a compass cardinal direction (i.e., north, south, east, west). The overall ViEWIT wind flag system can then make use of measurements against the orientation indicator 104 as further described herein.

A wind vane 102 may provide both visually observable physical movements and electronic measurements of wind and environmental conditions. A flag shaft 128 may be attached to a spin mount 130 that allows the wind vane assembly 102 to freely spin, as indicated by spin direction 192 and preferably in a horizontal plane, about the stand 108. A low-friction bearing assembly is one means of providing the free spin capability of spin mount 130, but other means are possible.

The wind vane 102 may further include a vertical fin 134 mounted to the flag shaft 128 and that is acted upon by the wind. The fin 134 serves to physically orient the wind vane 102 into the direction of the blowing wind. Fin 134 is arranged in this example embodiment as a trapezoidal shape which points into the wind (i.e., the narrow dimension faces the wind). Other configurations and arrangements are possible, such as a fin position that causes the wind vane 102 to face downwind instead of into the wind. In such a configuration, the fin 134 may further be reversed such that the trapezoid points downwind. The fin 134 should be large enough to be easily observable from a distance and therefore provide an instantaneous physically-observable indication of wind direction to a distant shooter. The trapezoidal shape is beneficial in that provides an exaggerated fore-shortened shape when viewed at an angle other than perpendicular to the side face of fin 134.

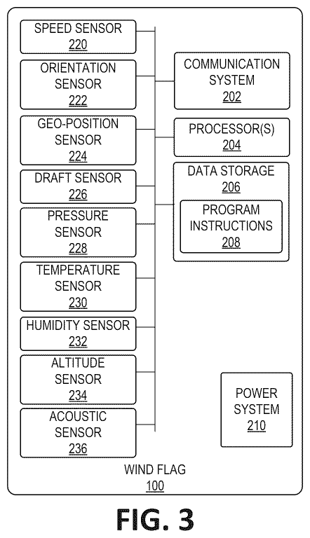

The wind vane 102 may further include a propeller 122 spinnably mounted, as indicated by spin direction 190 and preferably in a vertical plane, to the flag shaft 128. The propeller 122 is spun by the wind, with the rate of spin viewable by the shooter and physically indicative of the wind velocity. A speed sensor component 126, as part of a speed sensor 220 (see, e.g., FIG. 3), may be mounted to the flag shaft 128 and may read a rate of spin of the propeller 122, e.g., via direct physical contact with a hub of the propeller and/or via an optical, magnetic, or electronic rotational speed counter. The speed sensor component 126 may interface with the rest of speed sensor 220 which may be included in a housing 120 mounted to the flag shaft 128 (or elsewhere) and the speed sensor 220 may be configured to measure, record, transmit, receive, and/or transform measured propeller 122 spin speed data. A wired (and/or wireless) connection (not shown) may be present between the speed sensor component 126 mounted near the propeller 122 and the rest of speed sensor 220 components mounted in the housing 120. The propeller 122 should be large enough to be easily observable from a distance and therefore provide an instantaneous physically-observable indication of wind velocity to a distant shooter. The size of the propeller 122 in the example embodiment illustrated in FIG. 1 may be changed to reflect appropriate sizing for long-distance viewing.

The wind vane 102 may further include an orientation sensor component 132, as part of orientation sensor 222, mounted, e.g., to spin mount 130. The orientation sensor component 132 may read the orientation of the wind vane 102 (e.g., along the axis of the flag shaft 128) relative to the direction of the orientation indicator 104. For example, the orientation sensor component 132 may include an encoder reader that interacts with features included on the orientation indicator 104 (e.g., an encoder wheel) to determine or help determine, at the orientation sensor 222, a relative orientation between fixed orientation indicator 104 and the wind vane 102 as it is rotated by the wind about the stand 108 and the.

The ViEWIT wind flag 100 may further include a draft indicator 106, which can provide a physically observable indication of instantaneous updraft and downdraft current conditions, as well as providing electronic data of the same. The draft indicator 106, as illustrated in this example embodiment, can be rotatably mounted, as indicated by rotation direction 198 and preferably in a horizontal plane, to the stand 108 via a rotational mount 164. A set screw 166 or other fixation means can be used to fix the draft indicator 106 in place and prevent further rotation about the stand 108. The draft indicator 106 may include a draft pointer 150 that freely pivots (e.g., rotates) about a pivot mount 158, as indicated by pivot direction 196 and preferably in a vertical plane, in response to updraft or downdraft currents. The draft pointer 150 may include a flap 154 for catching updrafts and downdrafts, a counterweight 160 for balancing the draft pointer 150 in a neutral (e.g., horizontal) position when no drafts are present, and a shaft 152 connecting the flap 154 and counterweight 160 to the pivot mount 158.

The draft indicator 106 may further include a draft scale 162 with visible tick marks mounted to the rotational mount 164, wherein the draft pointer 150 pivots about the draft scale 162 in response to updrafts and down drafts, and both together provide a physically observable indication of instantaneous updraft and downdraft current conditions. A chevron 156 or similar mark may be present on the draft pointer 150 to provide an easily observable pivot orientation of the draft pointer 150 relative to the draft scale 162.

The draft indicator 106 may further include a pivot sensor component 168, as part of draft sensor 226, mounted, e.g., to rotational mount 164. The pivot sensor component 168 may read the pivot angle of the draft pointer 150 relative to a horizontal or ground plane. For example, the pivot sensor component 168 may include an encoder sensor that interacts with features included on the draft pointer 150 (e.g., an encoder wheel) to determine or help determine at the draft sensor 226 the current pivot angle of the draft pointer 150 as the draft pointer 150 is pivoted by updraft and downdraft currents about a horizontal neutral position.

FIG. 2 depicts a top view of the ViEWIT wind flag 100 depicted in FIG. 1, according to an example embodiment.

The top view of FIG. 2 helps to further illustrate one of many possible alignments of orientation indicator 104, which may be rotatably aligned and subsequently fixed via the set screw 144 or other fixation means as described with respect to FIG. 1.

The top view of FIG. 2 also further illustrates the use of legs 110, here illustrated as tripod legs, for stable placement of the ViEWIT wind flag 100 on the ground or other surface.

FIG. 3 is a simplified block diagram illustrating components of a ViEWIT wind flag, such as ViEWIT wind flag 100, according to an example embodiment.

ViEWIT wind flag 100 includes data storage 206 which may store program instructions 208 for running via one or more processors 204 as well as storing any saved data, including reference table data and/or data from the sensors of the ViEWIT wind flag 100. The processor(s) 204 may include general-purpose processors and/or special purpose processors (e.g., digital signal processors, application specific integrated circuits, etc.). One or more of the processor(s) 204 may be configured to execute computer-readable program instructions 208 that are stored in the data storage 206. Execution of the program instructions 208 can cause the ViEWIT wind flag 100 to provide at least some of the functions described herein.

The ViEWIT wind flag 100 may further include a power system 210 which may provide power to components in the ViEWIT wind flag 100 and may itself be powered by mains, internal or external battery power, or other sources or combinations of sources, such as solar and battery.

The ViEWIT wind flag 100 may further include a communication system 202. The communications system 202 may include one or more wireless interfaces and/or one or more wireline interfaces, which allow the ViEWIT wind flag 100 to communicate via one or more networks. Such wireless interfaces may provide for communication under one or more wireless communication protocols over antenna 124 by any suitable means, including, but not limited to, Bluetooth, Wifi, LoRa, LoRaWAN, DoRa, cellular data, and the like. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. The ViEWIT wind flag 100 may communicate with the base station 300, other ViEWIT wind flags 100, and/or other devices (e.g., a mobile device) via the communication system 202. The communication system 202 may allow for both short-range communication and long-range communication and operate on one or more networks. For example, the ViEWIT wind flag 100 may be configured to function as a proxy, repeater, or mesh node between and among other ViEWIT wind flags 100, the base station 300, and/or other devices (e.g., a mobile device). Configured as such, the communication system 202 may operate to serve data communications to/from such devices.

The ViEWIT wind flag 100 may include a speed sensor 220. The speed sensor 220 provides data indicative of wind velocity measured at the ViEWIT wind flag 100. In one embodiment, as described with respect to FIG. 1, the speed sensor 220 includes a speed sensor component 126 that measures the spin speed of the propeller 122.

In another embodiment, the speed sensor 220 may alternatively or additionally include a different sensor component (not shown) that measures data indicative of the wind velocity at ViEWIT wind flag 100 without reference to the spin speed of the propeller 122—for example, a digital anemometer. In such an embodiment, such a sensor component may not be mounted to the wind vane 102 and may alternatively or additionally be mounted elsewhere on the wind flag 100.

In one embodiment, processor 204 receives data from speed sensor 220 and may transform the data, via, e.g., computation and/or lookup in stored data tables, into a determined wind velocity at the particular ViEWIT wind flag 100. The received data and/or the determined wind velocity may ultimately be transmitted to a base station 300 along with other data, such as an identification associated with the particular ViEWIT wind flag 100, positional data, and/or time stamp data. The received data and/or the determined wind velocity may also be stored in the data storage 206 prior to and/or after transmission along with other data, such as an identification associated with the particular ViEWIT wind flag 100, positional data, and/or time stamp data. Additionally or alternatively, the processor(s) 204 may determine a wind velocity over a period of time (e.g., an average wind velocity), or data indicative of such, and ultimately cause that determined wind velocity over time), or data indicative of such, to be transmitted to the base station 300.

The ViEWIT wind flag 100 may include an orientation sensor 222. The orientation sensor 222 provides data indicative of the orientation of the wind vane 102 relative to a known direction. In one embodiment, as described with respect to FIG. 1, the orientation sensor 222 includes an orientation sensor component 132 that determines data indicative of the current orientation of the wind vane 102 relative to the orientation indicator 104.

In another embodiment, the orientation sensor 222 may alternatively or additionally include a sensor component (not shown) that determines the orientation of the wind vane 102, or data indicative of such, against a known reference, such as a compass cardinal direction. For example, the orientation sensor 222 may include an electronic compass component such as a magnetometer that provides data indicative of an orientation of the wind vane 102 with respect to the Earth's magnetic field, compass cardinal point or other compass heading, or a derived relative angle against such.

As another example, the orientation sensor 222 may additionally or alternatively include an inertial measurement unit, such as a gyroscope, which may be used to determine an orientation of the wind vane 102 after an initial reference orientation is set. In particular, the gyroscope can measure the rotation of the wind vane 102 around a vertical axis, such as a centerline of the stand 108 and the initial reference orientation may be parallel to the theoretical target line.

In one embodiment, processor 204 receives data from orientation sensor 222 and may transform the data, via, e.g., computation and/or lookup in stored data tables, into a determined orientation of wind vane 102 at the particular ViEWIT wind flag 100. The received data and/or the determined orientation may ultimately be transmitted to a base station 300 along with other data, such as an identification associated with the particular ViEWIT wind flag 100, positional data, and/or time stamp data. The received data and/or the determined orientation may also be stored in the data storage 206 prior to and/or after transmission along with other data, such as an identification associated with the particular ViEWIT wind flag 100, positional data, and/or time stamp data. Additionally or alternatively, the processor may determine an orientation of wind vane 102 at the particular ViEWIT wind flag 100 over a period of time (e.g., an average orientation), or data indicative of such, and ultimately cause that determined orientation over time, or data indicative of such, to be transmitted to the base station 300.

The ViEWIT wind flag 100 may include a geo-position sensor 224. The geo-position sensor 224 provides data indicative of the geo-position of the particular ViEWIT wind flag 100. In one embodiment, the geo-position sensor 224 may include a GPS sensor that determines the GPS coordinates of the particular ViEWIT wind flag 100.

In one embodiment, processor 204 receives data from geo-position sensor 224 and may ultimately transmit that data to a base station 300. Additionally or alternatively, the processor may transform the received geo-position data into another format through computation or stored look up tables and transmit that transformed data. The geo-position data may also be stored in the data storage 206 prior to and/or after transmission along with other data, such as time stamp data.

The ViEWIT wind flag 100 may include a draft sensor 226. The draft sensor 226 provides data indicative of updraft and/or downdraft velocity measured at the ViEWIT wind flag 100. In one embodiment, as described with respect to FIG. 1, the draft sensor 226 includes a pivot sensor component 168 that measures the pivot angle of the draft pointer 150.

In another embodiment, the draft sensor 226 may alternatively or additionally include a different sensor component (not shown) that measures data indicative of the updraft and/or downdraft velocity at ViEWIT wind flag 100 without reference to the pivot angle of the draft pointer 150—for example, a digital anemometer adapted to measure wind movement in a vertical axis. In such an embodiment, such a sensor component may not be mounted to the wind vane 102 and may alternatively or additionally be mounted elsewhere on the wind flag 100.

In one embodiment, processor 204 receives data from draft sensor 226 and may transform the data, via, e.g., computation and/or lookup in stored data tables, into a determined updraft and/or downdraft velocity at the particular ViEWIT wind flag 100. The received data and/or the determined updraft and/or downdraft velocity may ultimately be transmitted to a base station 300 along with other data, such as an identification associated with the particular ViEWIT wind flag 100, positional data, and/or time stamp data. The received data and/or the updraft and/or downdraft velocity may also be stored in the data storage prior to and/or after transmission along with other data, such as an identification associated with the particular ViEWIT wind flag 100, positional data, and/or time stamp data. Additionally or alternatively, the processor may determine a updraft and/or downdraft velocity over a period of time (e.g., an average updraft and/or downdraft velocity), or data indicative of such, and ultimately cause that determined updraft and/or downdraft velocity over time, or data indicative of such, to be transmitted to the base station 300.

Similarly as described above, a ViEWIT wind flag 100 may additionally or alternatively include environmental condition sensors, such as a pressure sensor 228 (e.g., a barometric pressure sensor), a temperature sensor 230, a humidity sensor 232 (e.g., a hygrometric sensor), and/or an altitude sensor 236 (e.g., an altimeter sensor). These sensors may function and be employed similar as recited above. For example, these environmental condition sensors can provide data indicative of their measured environmental condition, as measured at the ViEWIT wind flag 100. The processor 204 may receive data from one of the environmental condition sensors and may transform the data, via, e.g., computation and/or lookup in stored data tables, into a determined condition at the particular ViEWIT wind flag 100. The received data and/or the determined condition may ultimately be transmitted to a base station 300 along with other data, such as an identification associated with the particular ViEWIT wind flag 100, positional data, and/or time stamp data. The received data and/or the determined condition may also be stored in the data storage 206 prior to and/or after transmission along with other data, such as an identification associated with the particular ViEWIT wind flag 100, positional data, and/or time stamp data. Additionally or alternatively, the processor may determine an environmental condition over a period of time (e.g., an average condition), or data indicative of such, and ultimately cause that determined environmental condition, or data indicative of such, to be transmitted to the base station 300.

The ViEWIT wind flag 100 may include an acoustic sensor 236. The acoustic sensor 236 may provide data indicative of a bullet firing and/or a target hit (e.g., on a steel target) as measured, respectively, by the report (i.e., explosive sound of bullet firing) and/or the target ping (i.e., sound of bullet hitting the target) received acoustically at the ViEWIT wind flag 100.

In one embodiment, processor 204 receives data from acoustic sensor 236 and operates on the data, via, e.g., computation and/or lookup in stored data tables, to determine whether the data indicates an event such as a report or a target ping. The received data and/or the determined event may ultimately be transmitted to a base station 300 along with other data, such as an identification associated with the particular ViEWIT wind flag 100, positional data, and/or time stamp data. The received data and/or determined event may also be stored in the data storage 206 prior to and/or after transmission along with other data, such as an identification associated with the particular ViEWIT wind flag 100, positional data, and/or time stamp data.

### II. Example Base Station

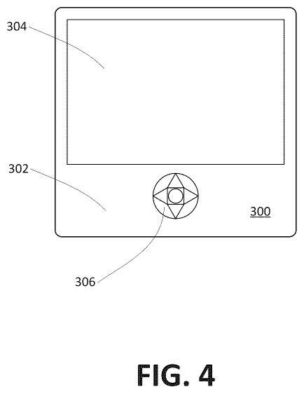

FIG. 4 depicts a front view of base station, according to an example embodiment.

Base station 300 is intended to be located near the shooter (e.g., at the shooting station), receive data from one or more ViEWIT wind flags 100 located downrange towards the target, provide real time and historical data, and computational analysis and results, to the shooter to make elevation and windage adjustments to the rifle scope, final holdover aim point adjustments through the scope reticle, and to provide a user interface with display and a user input for the shooter.

In the example embodiment illustrated in FIG. 4, base station 300 includes a case 302, a display 304, and a user input 306. The display 304 may provide a text-based display and/or a graphical user interface (“GUI”), with content further described below. The user input 306 may include buttons or touch-sensitive screen elements (not shown) for power, GUI navigation, and/or other input.

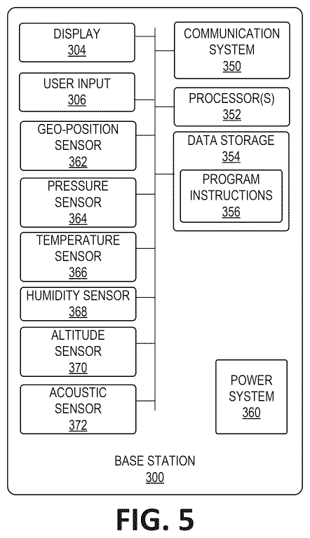

FIG. 5 is a simplified block diagram illustrating components of a base station, such as base station 300, according to an example embodiment.

Base station 300 includes data storage 354 which may store program instructions 356 for running via one or more processors 352 as well as storing any saved data, including reference table data and/or data from the sensors of the base station 300. The processor(s) 352 may include general-purpose processors and/or special purpose processors (e.g., digital signal processors, application specific integrated circuits, etc.). One or more of the processor(s) 352 may be configured to execute computer-readable program instructions 356 that are stored in the data storage 354. Execution of the program instructions 356 can cause the base station 300 to provide at least some of the functions described herein.

The base station 300 may further include a power system 360 which may provide power to components in the base station 300 and may itself be powered by mains, internal or external battery power, or other sources or combinations of sources, such as solar and battery.

The base station 300 may further include a communication system 350. The communications system 350 may include one or more wireless interfaces and/or one or more wireline interfaces, which allow the base station to communicate via one or more networks. Such wireless interfaces may provide for communication under one or more wireless communication protocols over one or more antennae by any suitable means, including, but not limited to, Bluetooth, Wifi, LoRa, LoRaWAN, DoRa, cellular data, and the like. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. The base station 300 may communicate with one or more ViEWIT wind flags 100, and/or other devices (e.g., a mobile device) via the communication system 350. The communication system 350 may allow for both short-range communication and long-range communication and operate on one or more networks. Where the base station 300 has capability to transmit to other devices, the base station 300 may be configured to function as a proxy, repeater, or mesh node between and among ViEWIT wind flags 100 and/or other devices (e.g., a mobile device). Configured as such, the communication system 350 may operate to serve data communications to/from such devices.

The base station 300 may include a geo-position sensor 362. The geo-position sensor 362 provides data indicative of the geo-position of the base station 300. In one embodiment, the geo-position sensor 362 may include a GPS sensor that determines the GPS coordinates of the base station 300.

In one embodiment, processor 352 receives data from geo-position sensor 362 and may operate on that data by performing computational operations. Additionally or alternatively, the processor 352 may transform the geo-position data from geo-position sensor 362 into another format through computation or stored look up tables and/or operate on that transformed data. The geo-position or transformed data may also be stored in the data storage 354 along with other data, such as time stamp data. Further, the processor 352 may cause the geo-position or transformed data to be displayed at the base station 300.

Similarly as described above with respect to a ViEWIT wind flag 100, the base station 300 may additionally or alternatively include environmental condition sensors, such as a pressure sensor 364 (e.g., a barometric pressure sensor), a temperature sensor 366, a humidity sensor 368 (e.g., a hygrometric sensor), and/or an altitude sensor 370 (e.g., an altimeter sensor). These sensors may function and be employed similar as recited above. For example, the environmental condition sensors can provide data indicative of their measured condition, as measured at the base station 300. The processor 352 may receive data one or more of the environmental condition sensors and may operate on that data by performing computational operations. Additionally or alternatively, the processor 352 may transform the received data into another format through computation or stored look up tables and/or operate on that transformed data. The received data or transformed data may also be stored in the data storage 354 along with other data, such as time stamp data and/or geo-position data and/or displayed on the base station 300. Additionally or alternatively, the processor 352 may determine an environmental condition over a period of time (e.g., an average condition), or data indicative of such, and ultimately cause the determined environmental condition, or data indicative of such, to be operated on, displayed, and/or stored at the base station 300.

The base station 300 may include an acoustic sensor 372. The acoustic sensor 372 may provide data indicative of a bullet firing and/or a target hit (e.g., on a steel target) as measured, respectively, by the report (i.e., explosive sound of bullet firing) and/or the target ping (i.e., sound of bullet hitting the target) received acoustically at the base station 300.

In one embodiment, processor 352 receives data from acoustic sensor 372 and operates on the data, via, e.g., computation and/or lookup in stored data tables, to determine whether the data indicates an event such as a report or a target ping. Additionally or alternatively, the processor 352 may transform the received acoustic data into another format through computation or stored look up tables and/or operate on that transformed data. The received data or transformed data may also be stored in the data storage 354 along with other data, such as time stamp data and/or geo-position data, and/or displayed on the base station 300.

### III. Range Layout and Trajectory Compensation

FIG. 6 illustrates a simplified top view, not to scale, of a target range 400 with a ViEWIT wind flag system, according to an example embodiment.

In a common target shooting arrangement, such as benchrest target shooting, as depicted on target range 400 in FIG. 6, a shooter and a rifle 454 are positioned at a shooting station 450. It should be noted that term “rifle,” as used herein, is illustrative only and can instead mean any target shooting gun commonly used in target shooting sports, such as long-barrel firearms, short-barrel firearms, pistols, and air guns. The use of the illustrative term “rifle” herein therefore should not be construed as limiting to a specific type of target shooting gun commonly used in target shooting sports in any embodiment herein. Similarly, the illustrative term “bullet” herein should be construed to include projectiles from common target shooting guns, including target shooting bullets and air gun projectiles.

A target 452 is positioned downrange some distance away from the shooting station 450, and a theoretical target line 460 exists from the end of the rifle 454 to the center of the target 452. In this example, the theoretical target line 460 is aligned along an East-West compass axis, as depicted by the compass 402, with the target 452 downrange in the direction of the East cardinal point. No distinction is made in this example between magnetic North and true North as it is not necessary for the description of this example target range 400. The alignment of the theoretical target line 460 along the East-West compass axis is done for ease of illustration in this FIG. 6 embodiment only and is not a requirement.

The distance from rifle 454 to target 452 may be any common target shooting distance, for example, from 25 to 100 meters, from 100 meters to 1000 meters, or longer. The target 452 may be at approximately the same altitude as the rifle 454, or may be significantly up slope or down slope from the rifle 454. (The term “altitude” is used here to refer to a height difference between rifle 454 and target 452 in order to minimize confusion with “elevation” adjustments of the rifle 454 scope, which are done to compensate for bullet drop over long trajectories.)

A ViEWIT base station 300 is positioned near the rifle 454 at the shooting station 450. The base station 300 is in communication with a first ViEWIT wind flag 100A, a second ViEWIT wind flag 100B, and a third ViEWIT wind flag 100C, each of which may take the form of the example ViEWIT wind flag 100. In this example embodiment, ViEWIT wind flag 100A is placed closest to the rifle 454 position and in proximity to the theoretical target line 460. Upon placement, the orientation indicator 104A of ViEWIT wind flag 100A may be aimed and subsequently fixed parallel to the theoretical target line 460, which is also along the East-West compass axis. Similarly, in this example embodiment, ViEWIT wind flag 100B is placed approximately halfway between the rifle 454 position and the target 452 and in proximity to the theoretical target line 460, while ViEWIT wind flag 100C is placed closest to the target 452 and in proximity to the theoretical target line 460. In each case, the respective orientation indicators 104B and 104C may be aimed and subsequently fixed parallel to the theoretical target line 460.

In preparation for, during, and after shooting, the ViEWIT wind flags 100A-C collect, transform, operate on, and/or store data, while also transmitting data ultimately to the base station 300. Depending on location, weather, day, and time of day, there may be significant variations in wind conditions and/or environmental conditions along the theoretical target line 460.

In this example, wind conditions 406 measured by and at the first ViEWIT wind flag 100A are 5.3 mph wind velocity at a 45° relative angle to the theoretical target line, which corresponds to a wind direction from Northwest to Southeast, as visually represented by a corresponding arrow in FIG. 6. In this example, first ViEWIT wind flag 100A further measures environmental conditions, such as ambient temperature of 74.2° F., atmospheric pressure of 30.05 inHg, and relative humidity of 68%. The first ViEWIT wind flag 100A is additionally located 24.3 yards downrange of the shooting station 450. That location can be manually determined and entered at the base station 300 by the shooter or determined by either or both the first ViEWIT windflag 100A and/or the base station 300, using, for example, either or both the respective geo-position sensor 224 and/or the geo-position sensor 362.

Similarly, in this example, wind conditions 406 measured by and at the second ViEWIT wind flag 100B are slower at 3.7 mph wind velocity at a 90°relative angle to the theoretical target line, which corresponds to a North to South wind direction, as visually represented by the corresponding arrow in FIG. 6. In this example, second ViEWIT wind flag 100B further measures environmental conditions, such as ambient temperature of 75.8° F., atmospheric pressure of 30.06 inHg, and relative humidity of 62%. The second ViEWIT wind flag 100B is additionally located 53.2 yards downrange of the shooting station 450. That location can be manually determined and entered at the base station 300 by the shooter or determined by either or both the second ViEWIT windflag 100B and/or the base station 300, using, for example, either or both the respective geo-position sensor 224 and/or the geo-position sensor 362.

Similarly again, in this example, wind conditions 406 measured by and at the third ViEWIT wind flag 100C are 4.1 mph wind velocity at a 63° relative angle to the theoretical target line, which corresponds to wind direction from North-Northwest to South-Southeast, as visually represented by the corresponding arrow in FIG. 6. In this example, third ViEWIT wind flag 100C further measures environmental conditions, such as ambient temperature of 77.9° F., atmospheric pressure of 30.05 inHg, and relative humidity of 58%. The third ViEWIT wind flag 100C is additionally located 78.7 yards downrange of the shooting station 450. That location can be manually determined and entered at the base station 300 by the shooter or determined by either or both the third ViEWIT windflag 100C and/or the base station 300, using, for example, either or both the respective geo-position sensor 224 and/or the geo-position sensor 362.

Ignoring elevation effects, which are not represented in this top view of the target range 400, a bullet fired from rifle 454 that was aimed along the theoretical trajectory line 460 in these wind conditions would incur wind deflection and follow, for example, illustrative trajectory 462, which has been exaggerated only for illustrative effect. By accounting for wind deflection according to data supplied from ViEWIT wind flags 104A-C, and subsequently transformed, operated on, and/or displayed at the base station 300, the shooter can use the ViEWIT system, including one or more wind flags 104A-C and base station 300, to make pre-shot compensating windage adjustments to the rifle 454 scope in order to fire along trajectory 464, which accounts for the wind deflection. Trajectory 464 has likewise been exaggerated in FIG. 6 only for illustrative effect. Similarly, the shooter can also utilize the ViEWIT system from base station 300 to make pre-shot compensating elevation adjustments to the rifle 454 scope.

Additionally, after adjusting the rifle 454 scope for proper elevation and windage compensation at a moment in time, the wind conditions along the length of the target range 400 may continue to vary over time. Beneficially, the ViEWIT wind flags 100A-C provide both: (i) electronic data for use in displays at the base station 300, and (ii) physical indications of wind conditions visually observable by the shooter (e.g., relative rate of propeller 122 spin, orientation angle of the wind vane 102, pivot of draft indication 150).

In one scenario, after setting windage compensation in the scope, the shooter can maintain a long-distance focus downrange and observe the physical indications on the ViEWIT wind flags 100A-C and immediately recognize any change in wind conditions from the setting conditions. This is advantageous because the shooter does not need to switch focus or head position to view the corresponding electronic data on the base station 300; the shooter can rely solely on the wind flags'visual cues.

In one scenario, when the wind conditions have changed since setting windage compensation in the scope, the shooter can wait for the wind conditions to revert to the setting conditions before taking the shot. Preferably, the shooter maintains a long-distance focus downrange, observing only the target 452 and the wind flags 100A-C and not the base station 300. When the shooter recognizes that the current wind conditions have returned to a state sufficiently similar to the setting wind conditions, the shooter can immediately take the shot.

In another scenario, when the wind conditions have changed since setting windage compensation in the scope, the shooter can observe the physical indications on the wind flags 100A-C, determine the relative wind condition differences from the setting conditions, and immediately adjust their holdover aim point in the scope reticle and take the shot.

Beneficially, in each scenario, because the visually observable physical indications of wind conditions are along the theoretical target line 460, the shooter can quickly assess any wind changes without having to significantly change their eye line from the long-distance focal point (the target 452) to an extremely near-field focus point (the base station 300) and back, which can result in undesirable head, rest, hold, and body movement and delayed or impaired target 452 re-acquisition through the rifle 454 scope.

Further benefits and features of the ViEWIT wind flag system are discussed in the next section with respect to information presented to the shooter by the base station 300.

### IV. Base Station Functionality and Display

In one embodiment, a user (e.g., the shooter) can enter, accept, review, and/or confirm at the base station 300 data indicative of: the hypothetical target line orientation (e.g., a magnetic compass heading or cardinal direction) between the shooting station 450 (or base station 300); a distance between the shooting station 450 (or base station 300) and the target 452; identification information associated with one or more ViEWIT wind flags 100 (e.g., descriptive location, descriptive name, reference color, etc., for one or more ViEWIT wind flags 100 in the system); a description of the current shooting event; and/or, data for ballistic calculations (e.g., cartridge caliber, bullet type, grain, sectional density, ballistic coefficient, expected velocity, altitude change between the shooting station 450 (or base station 300) and the target 452, etc.).

In one embodiment, the base station 300 may be set to display data from any one ViEWIT wind flag 100, including as an example, wind direction, wind velocity, environmental conditions, and/or geographic position of the respective ViEWIT wind flag 100.

In another embodiment, the base station 300 may concurrently display data from more than one selectable ViEWIT wind flags 100, including as an example, wind direction, wind velocity, environmental conditions, and geographic position of the respective ViEWIT wind flags 100.

In another embodiment, the base station 300 may determine and display an overall wind deflection down the length of the range on the bullet, which may include current overall wind deflection, overall wind deflection as a function of time, and/or overall wind deflection averaged over a time period.

In another embodiment, the base station 300 may determine and display an overall ballistic drop down the length of the range, adjusted for altitude changes between the base station 300 and the target and/or based on apparent wind-caused headwind, which may include current overall ballistic drop, overall ballistic drop as a function of time, and/or overall ballistic drop averaged over a time period

In another embodiment, the base station 300 may determine and display information for elevation adjustments and/or windage adjustments based on collected and analyzed data

In another embodiment, the base station may determine and display wind direction at one or more ViEWIT wind flags 100 correlated with a respective graphical representation of how the shape of the wind vane 102 fin 134 would appear to the shooter at that determined wind direction for that respective ViEWIT wind flag 100.

In another embodiment, the base station 300 may determine and display prevalent wind conditions—for example, a wind condition that is stable and/or repeating such that it occurs with greater durational frequency relative to other wind conditions. Additionally, the base station may display a graphical representation of how the shape of one or more wind vane 102 fins 134 would appear to the shooter for that prevalent wind condition.

In another embodiment, the base station 300 may determine and display wind conditions and/or other environmental data at the time of a shot in response to detecting a shot.

In another embodiment, the base station 300 may determine and display changes in wind conditions or other environmental data since the time of the last shot.

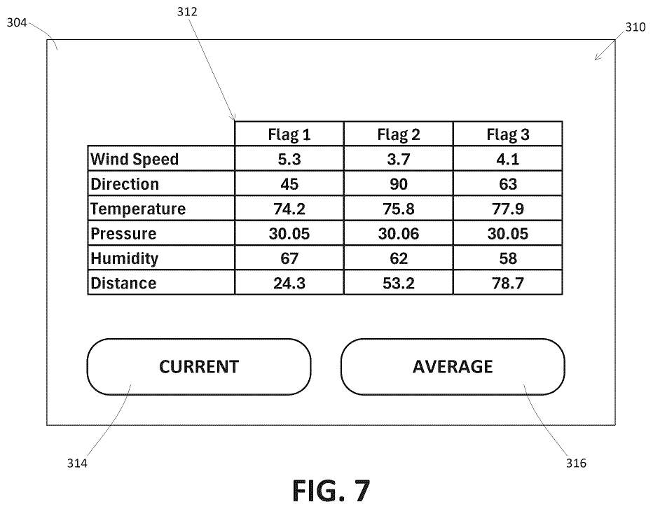

Features and benefits corresponding to above embodiments of the ViEWIT wind flag system 100 are discussed with respect to FIGS. 7-10.

FIG. 7 illustrates a data screen 310 displayed on a base station 300 display 304, according to an example embodiment. Base station 300 may cause display 304 to present the data screen 310 to the user (e.g., a shooter). The data screen 310 may include a data table 312 element. The data table 312 may show, for one or more selectable ViEWIT wind flags 100, wind conditions such as wind speed and/or wind direction, and/or environmental conditions such as ambient temperature, atmospheric pressure, and relative humidity.

The data table may alternatively or additionally show, for one or more selectable ViEWIT wind flags 100, their respective geographic location. As shown in data table 312, this location may be presented as a relative distance downrange of the shooting station 450 (or the base station 300). Alternative or additionally, other geographic location information may be displayed, such as: the relative perpendicular distance from the hypothetical target line; the relative non-dimensional position of a ViEWIT wind flag 100 relative to other ViEWIT wind flags 100 (e.g., first, second, third) (e.g., near, middle, far); the relative side, left or right, where one or more ViEWIT wind flags 100 are positioned relative to the hypothetical target line; the absolute altitude of one or more ViEWIT wind flags 100, or the relative altitude of one or more ViEWIT wind flags 100 relative to the base station 300 and/or target 452.

The data screen 310 may include a button 314, that when clicked by the user either through a touch screen input or manipulation of the user input 306 buttons, causes the data table 312 to display current data (e.g., instantaneous or recent smoothed) for the conditions described above. The data screen 310 may further include a similarly activatable button 316, that causes the data table 312 to alternatively or additional display average data for the conditions described above, such as data that has been averaged over a specific period, such as since the base station 300 was activated, or since the last shot was recorded, or over a specific time or for a current shooting session.

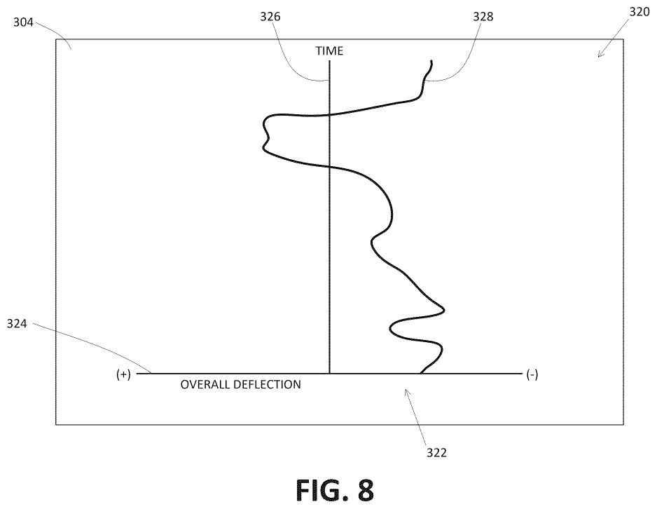

FIG. 8 illustrates a deflection-over-time screen 320 displayed on a base station 300 display 304, according to an example embodiment. Base station 300 may cause display 304 to present the deflection-over-time screen 320 to the user (e.g., a shooter). The deflection-over-time screen 320 may include a deflection chart 322 element.

In one embodiment, the deflection chart 322 may show overall wind deflection on a bullet as a function of time according to data received, analyzed, and processed by the ViEWIT wind flag system. For example, base station 300 may receive, from one or more ViEWIT wind flags 100, data indicative of one or more wind conditions and possibly one or more environmental conditions at one or more locations along the theoretical target line. The base station 300 may periodically or continuously determine and record, for specific times, an overall windage deflection (e.g., a directional value in appropriate units) that the bullet would experience as a result of wind conditions (and optionally environmental conditions) at the respective times. The base station 300 can then present a trendline 328 of that overall deflection data as function of time to the user via deflection chart 322. The trendline 328 may be plotted against an overall deflection axis 324 and a time axis 326. The time axis 326 may include tic marks and/or time values in a selected unit (e.g., seconds, minutes, etc.) and start at zero or start at some specific or relative time. The deflection axis may include tic marks and/or overall deflection values in a selected unit (e.g., minutes of angle (MOA), inches, centimeters, etc.) and may include both positive and negative scales to indicate whether the deflection would be to the left or right of the target center. Beneficially, a shooter can use the trendline 328 to determine an estimated a pre-shot windage compensation setting, e.g., for the rifle 454 scope.

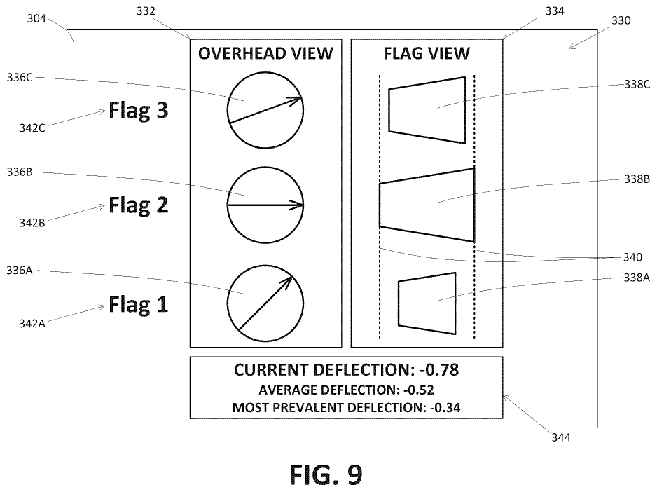

FIG. 9 illustrates a range condition screen 330 displayed on a base station 300 display 304, according to an example embodiment. Base station 300 may cause display 304 to present the range condition screen 330 to the user (e.g., a shooter). The range condition screen 330 may include an overhead view 332 element, a flag view 334 element, one or more flag identifier 342A-C elements, and a deflection indication 344 element.

The illustrative range condition screen 330 corresponds approximately to the ViEWIT wind flag system illustrated and described with respect to FIG. 6. Data from three ViEWIT wind flags 100 are displayed in respective rows.

The middle row, indicated as “Flag 2” by flag identifier 342B element, presents a corresponding overhead image 336B in the overhead view 332 element that graphically represents a wind direction of 90° relative to the hypothetical target line, as reflected in the wind conditions 406 for wind flag 100B in FIG. 6. The middle row further presents a flag image 338B in the flag view 334 element that graphically represents how fin 134 of wind flag 100B at that wind direction would appear to a shooter at shooting station 450 in FIG. 6. In this example, because the wind vane 102, and thus the fin 134, of wind flag 100B are effectively perpendicular to the shooter at shooting station 450 in FIG. 6, the flag image 338B is the widest it could appear. That flag image 338B is also not fore-shortened in height in the front or back due to the effects of perspective over distance.

Extents 340 are also included in flag view element 334 and are beneficial for providing a graphical indication of the maximum potential extents of a flag image 338A-C.

Similarly, the bottom row, indicated as “Flag 1” by the flag identifier 342A element, presents a corresponding overhead image 336A that graphically represents a wind direction of 45° relative to the hypothetical target line, as reflected in the wind conditions 406 for wind flag 100A in FIG. 6. The corresponding flag image 338A graphically represents how fin 134 of wind flag 100A would appear to the same shooter at that wind direction. Because the fin 134 of wind flag 100A is not perpendicular to the shooter, the flag image 338A is narrower than flag image 338B and also the back height is foreshortened relative to the front height due to the effects of perspective over distance.

Similarly again, the top row, indicated as “Flag 3” by the flag identifier 342C element, presents a corresponding overhead image 336C that graphically represents a wind direction of 63° relative to the hypothetical target line, as reflected in the wind conditions 406 for wind flag 100C in FIG. 6. The corresponding flag image 338C graphically represents how fin 134 of wind flag 100C would appear to the same shooter at that wind direction. Because the fin 134 of wind flag 100C is not perpendicular to the shooter, the flag image 338C is narrower than flag image 338B and also the back height is foreshortened relative to the front height due to the effects of perspective over distance. However, the flag image 338C for Flag 3 is not as narrow as flag image 338A for Flag 1 because Flag 3 is at 63° to the theoretical target line (or closer to perpendicular) as compared to Flag 1 at 45°.

The range condition screen 330 may further include the deflection indication 344 element, which may display a calculated overall deflection value for a bullet shot downrange in the wind conditions (and optionally environmental conditions) measured by the ViewIT wind flag system, as illustrated in FIG. 6. For example, as illustrated, the deflection indication 344 element displays a current deflection value of −0.78, indicating that for the conditions presented at the moment in range condition screen 330, a windage adjustment of −0.78 would be needed. Units for deflection values may be user selectable and could include, for example, minutes of angle (MOA), inches, or centimeters. Additionally or alternatively, the deflection indication 344 element may also display an average deflection value, here illustrated as −0.52, indicating that for average conditions over a specified period of time, a windage adjustment of −0.52 would be needed. Additionally or alternatively, the deflection indication 344 element may also display a most prevalent deflection value, here illustrated as −0.34, indicating that for the most prevalent conditions (e.g., as measured by duration of time), a windage adjustment of −0.34 would be needed.

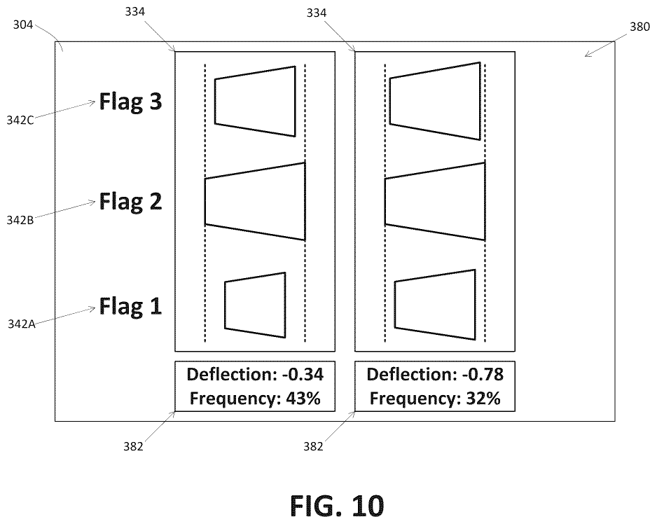

FIG. 10 illustrates a prevalent conditions screen 380 displayed on a base station 300 display 304, according to an example embodiment. The prevalent conditions screen 380 may include one or more flag view 334 elements as in FIG. 9, one or more flag identifier 342A-C elements as in FIG. 9, and one or more prevalent condition indication 382 elements.

The illustrative prevalent conditions screen 380 corresponds approximately to the ViEWIT wind flag system illustrated and described with respect to FIG. 6. Data from three ViEWIT wind flags 100 are displayed in respective rows.

The one or more flag view 334 elements and one or more flag identifier 342A-C elements are as described with respect to FIG. 9, except each flag view 334 element corresponds to a prevalent wind condition.

An example of a prevalent wind condition is a wind condition where the wind velocity is relatively stable (e.g., with a predetermined variance) across the set of wind flags 100A-C for periods of time and the wind direction at each wind flag 100A-C is relatively stable at the respective wind flag.

In another example, the prevalent wind condition may be characterized by having a periodically recurring wind velocity within a pre-determined variance and/or periodically recurring wind direction within a predetermined variance at each wind flag 100A-C, where the recurring wind velocity and/or wind direction are correlated with similar recurrences in time across the set of wind flags 100A-C.

The base station 300 may record wind conditions over time across each wind flag 100A-C and determine correlations across the set of wind flags 100A-C to determine a prevalent condition. The base station may further calculate a set of time periods (as measured by total duration) where the ViEWIT wind flag system has measured, and/or is measuring, the same respective stable wind conditions or periodically recurring wind conditions (e.g., within a predetermined variance). The base station 300 may select the longest duration time period from the set and the corresponding wind conditions as the most prevalent condition. Similarly, the base station 300 may select the next longest duration time period from the set and the corresponding wind conditions as the next most prevalent condition. The base station 300 may repeat this operation multiple times, in each case selecting the next longest duration time period.

In one embodiment, the base station 300 may cause the display 304 to update a flag view 334 element in the prevalent conditions screen 380 to reflect the most prevalent condition. The base station 300 may further cause the display 304 to update another flag view 334 element in the prevalent conditions screen 380 to reflect the second most prevalent condition.

The prevalent conditions screen 380 may further include one or more one or more prevalent condition indication 382 elements, which may display a calculated overall deflection value for a bullet under the corresponding prevalent wind conditions, similarly as described with FIG. 9. For example, as illustrated in FIG. 10, the left prevalent condition indication 382 element displays an overall deflection value of −0.34, indicating that for the wind conditions present during that prevalent condition, wherein the wind flags 100A-C will exhibit fin 134 shapes graphically shown in the corresponding left flag view 334 element, a windage adjustment of −0.34 would be needed. As with FIG. 9, units for deflection values may be user selectable and could include, for example, minutes of angle (MOA), inches, or centimeters.

The prevalent condition indication 382 elements may further display a frequency with which the corresponding prevalent condition has occurred. For example, the left prevalent condition indication 382 element displays a frequency of 43%, which indicates that the ViEWIT wind flag system has measured that particular prevalent condition 43% of the time, within some pre-determined time interval.

Similarly, the right prevalent condition indication 382 element displays an overall deflection value of −0.78, which occurred 32% of the time. The corresponding right flag view 334 element graphically displays what the fins 134 will look like to the shooter under that prevalent condition.

This prevalent conditions screen 380 is beneficial in a scenario where the shooter has set their windage adjustment to a prevalent condition. The shooter can then maintain a long-distance focus downrange, observing only the target 452 and the wind flags 100A-C and not the base station 300. As soon as the shooter recognizes that the current wind conditions have returned to a prevalent wind condition, based at least in part on the fin 134 shapes, the shooter can immediately take the shot.

### V. Range Layout and Communications

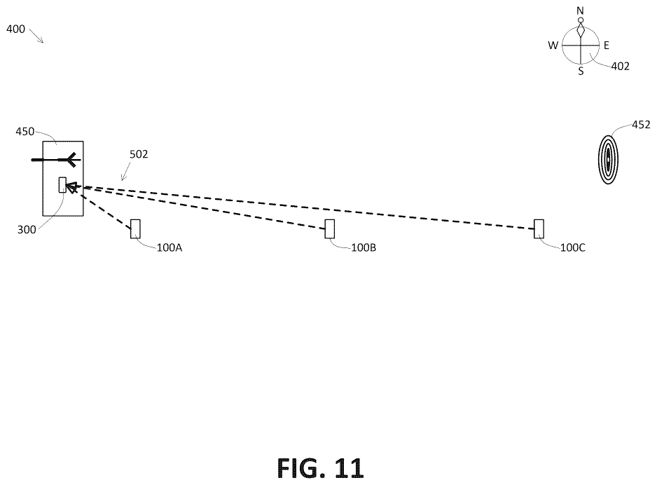

FIG. 11 illustrates a simplified top view, not to scale, of a target range 400 with a ViEWIT wind flag system operating in a direct communication mode, according to an example embodiment.

Similarly to FIG. 6, a series of individual ViEWIT wind flags 100A-C are shown operating on target range 400. (The ViEWIT wind flags 100A-C are represented as boxes solely for simplicity of illustration.) The series of ViEWIT wind flags 100A-C operate in a direct communication mode and form a direct communication network 502 with base station 300 located proximate to the rifle 454. At shorter communication ranges, the ViEWIT wind flags 100A-C may effectively communicate directly with the base station 300 without loss of data or undesirable power consumption due to boosted data transmission power.

As in FIG. 6, the shooting station 450 is located at a first end of the target range 400. The target 452 is located at a second end of the target range 400. As in FIG. 6, the series of ViEWIT wind flags 100A-C are located proximate to, and along, a theoretical target line and downrange between the shooting station 450 and the target 452. The ViEWIT wind flags 100A-C are, in one embodiment, spaced evenly between the shooting station 450 and the target 452, though that is not a requirement. While the embodiment in FIG. 6 shows three ViEWIT wind flags 100A-C, more or less may be deployed within the schema.

In another or the same embodiment, the series of ViEWIT wind flags 100A-C may be located at high or low altitudes, either as necessary due to terrain or to capture data at different locations along a bullet drop trajectory. It is understood that the ViEWIT wind flags 100A-C may be placed in any suitable location as determined by the shooter, allowing the shooter to customize where they receive data from downrange.

When the series of ViEWIT wind flags 100A-C are operating in a direct communication network 502 with the base station 300, the ViEWIT wind flags 100A-C do not communicate with each other; they only transmit data directly to the base station 300.

At longer communication ranges, or as more ViEWIT wind flags 100 are added to a direct communication network with the base station 300, the ViEWIT wind flags 100A-C may have impaired ability to effectively communicate directly with the base station 300. Thus, alternative or additional network topologies are described below.

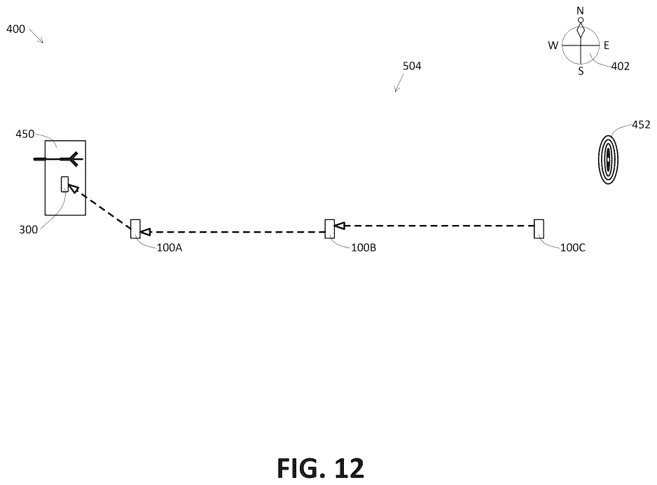

FIG. 12 illustrates a simplified top view, not to scale, of a target range 400 with a ViEWIT wind flag system operating in a repeater communication mode, according to an example embodiment.

Similarly to FIG. 11, a series of individual ViEWIT wind flags 100A-C are shown operating on target range 400. However, in this FIG. 12, the series of ViEWIT wind flags 100A-C operate in a repeater communication mode and form a repeater communication network 504 with base station 300 located proximate to the shooting station 450. While the embodiment in FIG. 12 shows three ViEWIT wind flags 100A-C, more or less may be deployed within the schema.

As in FIG. 11, the series of ViEWIT wind flags 100A-C: are located along a theoretical target line and downrange between the shooting station 450 and the target 452; are, in one embodiment, spaced evenly between the shooting station 450 and the target 452; and, in another or the same embodiment, may be located at high or low altitudes and may be placed in any suitable location as determined by the shooter

When a series of ViEWIT wind flags 100 are operating in a repeater communication network 504, data from distant ViEWIT wind flags 100 may be forwarded through one or more ViEWIT wind flags 100 nearer the base station 300 that act as nodes, with each node acting as a repeater for the data transmission, which may include pass through data forwarding and/or store-and-forward data transmission. In the simple embodiment illustrated in FIG. 12, data transmitted from ViEWIT wind flag 100C is received by ViEWIT wind flag 100B and then ultimately forwarded to ViEWIT wind flag 100A. Likewise, data transmitted from ViEWIT wind flag 100B, whether initially originating from ViEWIT wind flag 100C or ViEWIT wind flag 100B, is received by ViEWIT wind flag 100A and ultimately forwarded to base station 300. Finally, data originating at ViEWIT wind flag 100A is also transmitted to base station 300.

A repeater communication network 504 as contemplated herein is not limited to three ViEWIT wind flags 100 and may include more or less. Additionally or alternatively, in another embodiment (not illustrated), more than one ViEWIT wind flag 100 in a repeater communication network 504 may communicate directly with the base station 300. For example, in an alternative embodiment, a second set of ViEWIT wind flags 100 may have a repeater node arrangement similar to, but separate from, the node arrangement of ViEWIT wind flags 100A-C, with the ViEWIT wind flag 100 nearest to the base station 300 in that separate arrangement also communicating with base station 300.

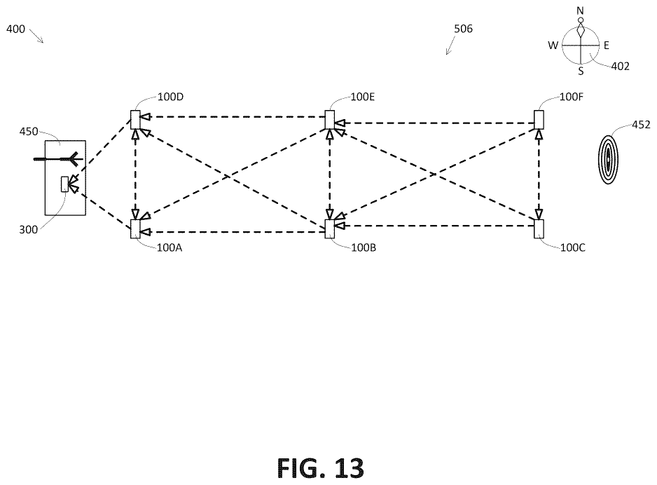

FIG. 13 illustrates a simplified top view, not to scale, of a target range 400 with a ViEWIT wind flag system operating in a mesh communication mode, according to an example embodiment.

Similarly to FIG. 11, a series of individual ViEWIT wind flags 100A-F are shown operating on target range 400. However, in this FIG. 13, the series of ViEWIT wind flags 100A-F operate in a mesh communication mode and form a mesh communication network 506 with base station 300 located proximate to the shooting station 450. While the embodiment in FIG. 13 shows six ViEWIT wind flags 100A-F, more or less may be deployed within the schema.

As in FIG. 11, the series of ViEWIT wind flags 100A-f: are located along a theoretical target line and downrange between the shooting station 450 and the target 452; are, in one embodiment, spaced evenly between the shooting station 450 and the target 452; and, in another or the same embodiment, may be located at high or low altitudes and may be placed in any suitable location as determined by the shooter

When the series of ViEWIT wind flags 100 are operating in a mesh network, each individual ViEWIT wind flag 100 may act as a node of the mesh network. Each acting node of the mesh network can both receive and transmit data from other nodes within communication range in the mesh network. This allows greater freedom of placement of ViEWIT wind flags 100 downrange while still allowing transmitted data from any ViEWIT wind flag 100 to ultimately reach the base station 500.

In the simple embodiment illustrated in FIG. 13, data transmitted from a distant ViEWIT wind flags 100C and 100F is received by ViEWIT wind flags 100B and/or 100C nearer the base station and then ultimately forwarded along to one more ViEWIT wind flags 100A or 100D closest to the base station 300, where the data is again ultimately forwarded to the base station 300. Likewise, data initially originating at intermediate ViEWIT wind flags 100B and 100E is received by ViEWIT wind flags 100A or 100D and ultimately forwarded to the base station 300, along with data initially originating at ViEWIT wind flags 100A or 100D.

A mesh communication network 506 as contemplated herein is not limited to six ViEWIT wind flags 100 and may include more or less. Additionally or alternatively, in another embodiment (not illustrated), more than one or two ViEWIT wind flag(s) 100 in a mesh communication network 504 may communicate directly with the base station 300.

### VI. Conclusion

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as expressly described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

1. A wind flag system comprising:
one or more wind flags (100), each wind flag comprising:
a visually-observable physical indication (134) of horizontal wind direction,
an electronic horizontal orientation sensor (222),
a visually-observable physical indication (122) of wind speed,
an electronic wind speed sensor (220), and
a wind flag communication system (202); and
a base station (300) comprising:
a display (304), and
a base station communication system (350),
wherein the base station is configured to:
receive horizontal wind direction data and wind speed data at each wind flag,
present on the display an indication of respective horizontal wind direction and respective wind speed at each wind flag,
present on the display an indication of a respective location of each wind flag, and
present on the display an indication of horizontal bullet deflection determined at least in part from received horizontal wind direction data and wind speed data.

2. The wind flag system of claim 1, wherein presenting on the display the indication of respective horizontal wind direction and respective wind speed at each wind flag comprises presenting a current respective horizontal wind direction and a current respective wind speed at each wind flag.

3. The wind flag system of claim 1, wherein presenting on the display the indication of respective horizontal wind direction and respective wind speed at each wind flag comprises presenting an average respective horizontal wind direction and an average respective wind speed at each wind flag.

4. The wind flag system of claim 1, wherein the one or more wind flags each further comprise an orientation indicator (104).

5. The wind flag system of claim 4, wherein presenting on the display the indication of respective horizontal wind direction at each wind flag comprises presenting each such indication relative to the orientation indicator of the respective wind flag.

6. The wind flag system of claim 1, wherein presenting on the display the indication of respective horizontal wind direction at each wind flag comprises presenting each such indication relative to a common direction based at least in part on data from each electronic horizontal orientation sensor.

7. The wind flag system of claim 1, wherein the one or more wind flags each further comprise a geo-position sensor (224), and wherein presenting on the display the indication of the respective location for each wind flag comprises presenting each such indication as a relative location of each respective wind flag.

8. The wind flag system of claim 7, wherein such indication is a distance relative to the base station.

9. The wind flag system of claim 7, wherein such indication is a location of each respective wind flag relative to at least one other wind flag.

10. The wind flag system of claim 1, wherein presenting on the display the indication of horizontal bullet deflection comprises presenting horizontal bullet deflection data as function of time.

11. The wind flag system of claim 10, further comprising presenting on the display a trendline (328) of horizontal bullet deflection data as function of time.

12. The wind flag system of claim 1 wherein presenting on the display the indication of horizontal bullet deflection comprises presenting a current horizontal bullet deflection and at least one of an average horizontal bullet deflection and/or a most prevalent horizontal bullet deflection.

13. The wind flag system of claim 1, wherein the base station is further configured to present on the display a graphical representation of horizontal wind direction (336A) for at least one wind flag and simultaneously present on the display a corresponding graphical representation (338A) of the visually-observable physical indication of horizontal wind direction for the least one wind flag.

14. The wind flag system of claim 1, wherein the base station is further configured to present on the display a graphical representation (334) of the visually-observable physical indication of horizontal wind direction for the least one wind flag for a prevalent condition and simultaneously present on the display an indication (382) of horizontal bullet deflection for the prevalent condition.

15. The wind flag system of claim 14, wherein the base station is further configured to simultaneously present on the display an indication (382) of the frequency with which the prevalent condition occurs.

16. The wind flag system of claim 1, wherein the wind flag communication system of at least one wind flag is configured to receive data from another wind flag and then transmit at least some of the received data.

17. The wind flag system of claim 1, wherein the visually-observable physical indication of wind speed is a propeller.

18. The wind flag system of claim 17, wherein each wind flag further comprises a speed sensor component (126) capable of reading a rate of spin of the respective propeller of the wind flag.

19. The wind flag system of claim 1, wherein the base station further comprises an acoustic sensor (372) configured to detect a bullet firing.

20. The wind flag system of claim 19, wherein the base station is configured to log an indication of horizontal wind speed and an indication of wind direction upon detecting a bullet firing.
